(19) United States
(12) Patent Application Publication
(10) Pub. No.: US 2006/0132687 A1
(43) Pub. Date: Jun. 22, 2006

(54) Liquid crystal display with optical compensation

(75) Inventors: Seng-Huei Chang, Padeh City (TW); Chien-Lin Pan, Padeh City (TW)

Correspondence Address: GENUS LAW GROUP;LOWE HAUPTMAN & BERNER, LLP, 1700 DIAGONAL ROAD, SUITE 300, ALEXANDRIA, VA, 22314, US

(73) Assignee: CHUNGHWA PICTURE TUBES, LTD.

(21) Appl. No.: 11/015,798

(22) Filed: Dec. 20, 2004

(51) Int. Cl. G02F 1/1335

(52) U.S. Cl. 349/117

(57) ABSTRACT

A liquid crystal display includes a first substrate, a second substrate, a liquid crystal layer, a first phase compensation plate, a second phase compensation plate, an optical compensation film, a first polarizer and a second polarizer. The liquid crystals of the liquid crystal layer are arranged in an optically compensated bend mode. The first phase compensation plate is located outside the first substrate. The second phase compensation plate is located outside the second substrate. The first phase compensation plate and the second phase compensation plate include layers of discotic liquid crystal in order to reduce the dark-state leakage of the liquid crystal layer. The optically compensated film may include a single-axis extension retardation plate (“A-plate”) located outside the first phase compensation plate in order to reduce the oblique leakage of the polarizers extending perpendicular to each other. The phase compensation plate and the optically compensated film reduce the dark-state leakage and the oblique leakage of the optically compensated bend mode display in order to increase the contrast and view angle of the liquid crystal display.

### BACKGROUND OF INVENTION

1. Field of the Invention

The present invention relates to a liquid crystal display with optical compensation and, more particularly, to an optically compensated bend mode liquid crystal display with optical compensation.

2. Related Prior Art

Liquid crystal displays are developing at a fast pace recently. All of the functional indicators of the liquid crystal displays have been increased remarkably. Hence, the liquid crystal displays are replacing cathode ray tube displays in the filed of computers. The liquid crystal displays are even replacing the cathode ray tube displays in the field of television. Because of the ever-increasing demand of motion pictures, the liquid crystal displays must be made with a high reaction speed in order to avoid residual pictures. The image quality of a conventional liquid crystal display varies tremendously at different view angles. To allow many people to watch one conventional liquid crystal display, a wide-view angle technique must be located in order to ensure that people receive same image quality at different view angles.

As shown in FIG. 1A, a conventional optically compensated bend mode liquid crystal display includes a first substrate 14, a second substrate 16, a liquid crystal layer 15, a first polarizer 10 and a second polarizer 18. The second substrate 16 is parallel to the first substrate 14. The liquid layer 15 is located between the first substrate 14 and the second substrate 16. The liquid crystals of the liquid crystal layer 15 are arranged in an optically compensated bend mode. The first polarizer 10 is located outside the first substrate 14. The second polarizer 18 is located outside the second substrate 16. The absorption axis of the first polarizer 10 is perpendicular to the absorption axis of the second polarizer 18. The optically compensated bend mode liquid crystal display includes a high reaction speed and therefore is suitable for showing motion pictures. Moreover, because of self-compensation, gray scale inversion does not occur at different view angles.

As shown in FIG. 1B, the conventional optically compensated bend mode liquid crystal display is shown. The isocontrast line 19 represents a view angle area at a contrast of 10:1. Although including a high reaction speed, the optically compensated bend mode liquid crystal display provides only a contrast of 30:1 to 40:1 at the center. This is because when the optically compensated bend mode liquid crystal display is driven at the dark state voltage, dark state leakage happens because of the optical anisotropy of the liquid crystal. Moreover, the polarizers, that are perpendicular to each other, cause oblique leakage. Thus, the contrast and the view angle are reduced.

As mentioned above, both the leakages include dark state leakage of a liquid crystal layer and the oblique leakage of two polarizers that are perpendicular to each other will reduce the contrast and view angle of the optically compensated bend mode liquid crystal display, so the problems must be overcome.

### SUMMARY OF THE INVENTION

It is the primary object of the present invention to use optical compensation in order to reduce leakages of an optically compensated bend mode liquid crystal display. The leakages include dark state leakage of a liquid crystal layer and oblique leakage of two polarizers that are perpendicular to each other. Thus, the contrast and view angle of the optically compensated bend mode liquid crystal display are improved.

To achieve the primary object, the present invention provides an optically compensated bend mode display includes a first substrate, a second substrate, a liquid crystal layer, a first phase compensation plate, a second phase compensation plate, an optical compensation film, a first polarizer and a second polarizer. The absorption axis of the first polarizer is perpendicular to the absorption axis of the second polarizer. The first phase compensation plate and the second phase compensation plate are used to reduce the dark state leakage of the liquid crystal layer. The optical compensation film is used to reduce the oblique leakage of the polarizers that are perpendicular to each other. Thus, the contrast and view angle of the liquid crystal display is improved.

The liquid crystal display with optical compensation of the present invention uses an optically compensated bend mode. Hence, it exhibits an advantage of a high reaction speed. The first phase compensation plate and the second phase compensation plate are used to reduce the dark-state leakage of the liquid crystal layer. The optical compensation film is used to reduce the oblique leakage of the polarizers that are perpendicular to each other. Therefore, it exhibits advantages of a high contrast and a wide view angle.

Other objects, advantages and novel features of the invention will become more apparent from the following detailed description in conjunction with the attached drawings.

### BRIEF DESCRIPTION OF DRAWINGS

FIG. 1A is a cross-sectional view of a conventional optically compensated bend mode liquid crystal display;

FIG. 1B is a whole-angle view of the conventional optically compensated bend mode liquid crystal display;

FIG. 2A is a cross-sectional view of an optically compensated bend mode liquid crystal display with phase compensation according to the present invention;

FIG. 2B shows the principle of phase compensation of the optically compensated bend mode liquid crystal display shown in FIG. 2A;

FIG. 2C is a whole-angle view of the optically compensated bend mode liquid crystal display shown in FIG. 2A;

FIG. 3A is a cross-sectional view of an optically compensated bend mode liquid crystal display with phase compensation according to the preferred embodiment of the present invention; and

FIG. 3B is a whole-angle view of the optically compensated bend mode liquid crystal display shown in FIG. 3A.

### DETAILED DESCRIPTION OF PREFERRED EMBODIMENT

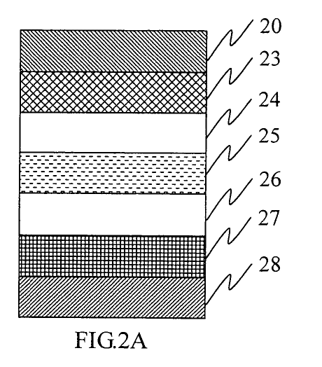

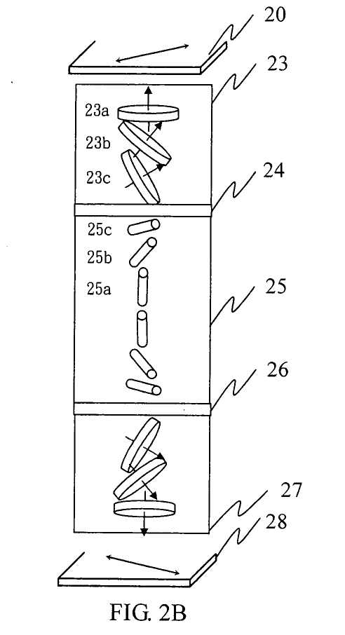

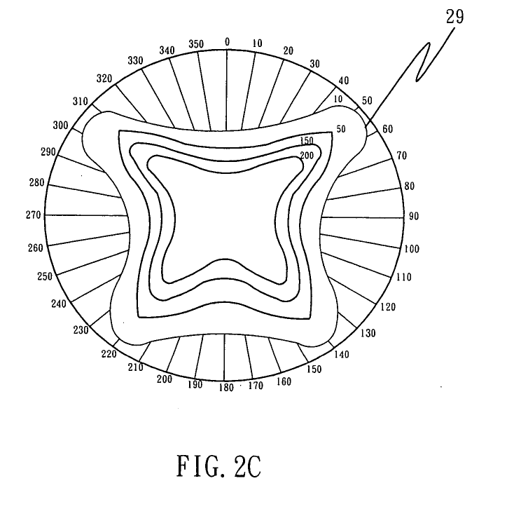

As shown in FIG. 2A, according to the present invention, a liquid crystal display includes a first substrate 24, a second substrate 26, a liquid crystal layer 25, a first phase compensation plate 23, a second phase compensation plate 27, a first polarizer 20, and a second polarizer 28. The second substrate 26 is perpendicular to the first substrate 24. The liquid crystal layer 25 is located on between the first substrate 24 and the second substrate 26. The liquid crystals of the liquid crystal layer 25 are arranged in an optically compensated bend mode. The first phase compensation plate 23 is located outside the first substrate 24. The second phase compensation plate 27 is located outside the second substrate 26. The first phase compensation plate 23 and the second phase compensation plate 27 include layers of discotic liquid crystal. The discotic liquid crystals are disc-shaped in order to reduce the dark state leakage of the liquid crystal layer 25. Thus, the contrast and view angle of the liquid crystal display is improved. The first polarizer 20 is located outside the first phase compensation plate 23. The second polarizer 28 is located outside the second phase compensation plate 27. The absorption axis of the first polarizer 20 is perpendicular to the absorption axis of the second polarizer 28.

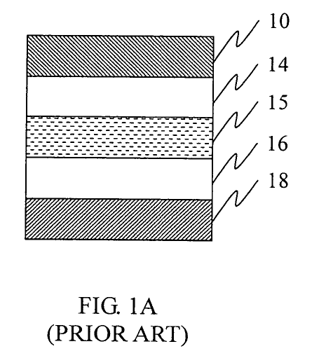

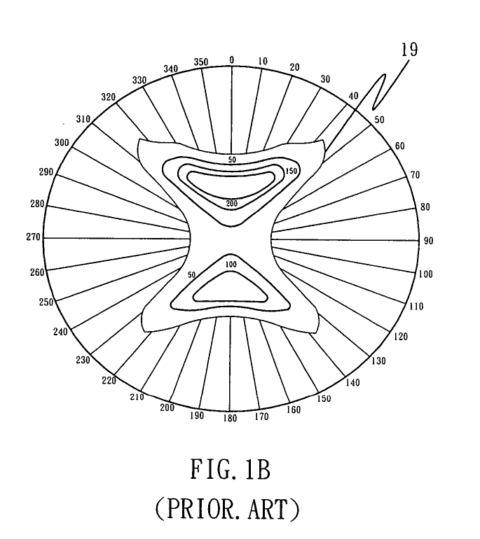

As shown in FIG. 2B, the principle of the phase compensation of the optically compensated bend mode liquid crystal display of the present invention is illustrated. The liquid crystals of the liquid crystal layer 25 are in an optically compensated bend mode. The liquid crystals in the optically compensated bend mode are arranged in a symmetrical manner. The columnar liquid crystals in a half of the liquid crystal layer 25 include layers 25a, 25b, and 25c. The first phase compensation plate 23 includes layers of disc-shaped liquid crystals, i.e., a layer 23a far from the first substrate 24, a layer 23c near the first substrate 24 and a layer 23b in the middle. The tilt angles of the disc-shaped liquid crystals increase from the layer 23a to the layer 23c. The layer 23a compensates phase difference generated in the layer 25a. The layer 23b compensates phase difference generated in the layer 25b. The layer 23c compensates phase difference generated in the layer 25c. Thus, the dark-state leakage of the liquid crystal layer 25 is reduced. Similarly, phase differences generated in the other half of the liquid crystal layer 25 are compensated by means of the second phase compensation plate 27. FIG. 2C is a whole-angle view of the optically compensated bend mode liquid crystal display with phase compensation. As shown in FIG. 2C, an iso-contrast line 29 represents a contrast of 10:1. The contrast and the view angle shown in FIG. 2C are remarkably better than that are shown in FIG. 1B.

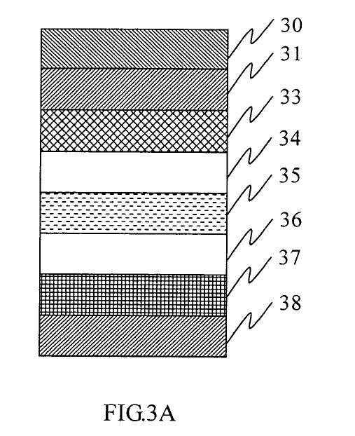

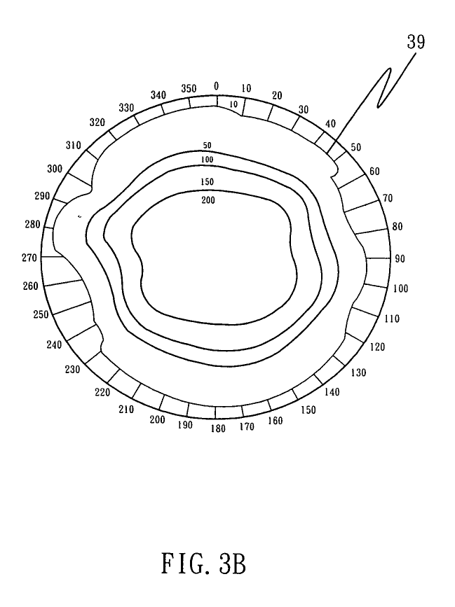

As shown in FIG. 3A, an optically compensated liquid crystal display with phase compensation plates and an optical compensation plate are shown. The optically compensated liquid crystal display includes a first substrate 34, a second substrate 36, a liquid crystal layer 35, a first phase compensation plate 33, a second phase compensation plate 37, an optical compensation film 31, a first polarizer 30 and a second polarizer 38. The second substrate 36 is parallel to the first substrate 34. The liquid crystal layer 35 is located on between the first substrate 34 and the second substrate 36. The liquid crystals of the liquid crystal layer 35 are arranged in an optically compensated bend mode. The first phase compensation plate 33 is located outside the first substrate 34. The second phase compensation plate 37 is located outside the second substrate 36. The first phase compensation plate 33 and the second phase compensation plate 37 include layers of discotic liquid crystal. The discotic liquid crystals are disc-shaped in order to reduce the dark-state leakage of the liquid crystal layer 35. Thus, the contrast and view angle of the liquid crystal display is improved. The optical compensation film 31 is located outside the first phase compensation plate 33. The first polarizer 30 is located outside the optical compensation film 31. The second polarizer 38 is located outside the second phase compensation plate 37. The absorption axis of the first polarizer 30 is perpendicular to the absorption axis of the second polarizer 38. The optical compensation film 31 may be a single-axis extension retardation plate (“A-plate”). The retardation axis of the optical compensation film 31 is perpendicular to the absorption axis of the first phase compensation plate 33 in order to reduce oblique leakage between the polarizers that are perpendicular to each other.

In the preferred embodiment of the present invention, the layer gap is 4.5 μm. The optical phase retardation of the liquid crystal layer 35 is 400 nm to 800 nm and, more preferably, 625 nm. The pre-tilt angle of the liquid crystal layer 35 is 6° to 10° and, more preferably 8°. The tilt angle of the disc-shaped liquid crystals of the first phase compensation plate 33 far from the first substrate 34 is 0° to 5° and, more preferably, 0°. The tilt angle of the disc-shaped liquid crystals of the first phase compensation plate 33 near the first substrate 34 is 30° to 40° and, more preferably, 35°. The tilt angle of the disc-shaped liquid crystals of the second phase compensation plate 37 far from the second substrate 36 is 0° to 5° and, more preferably, 0°. The tilt angle of the disc-shaped liquid crystals of the second phase compensation plate 37 near the second substrate 36 is 30° to 40° and, more preferably, 35°. The optical phase retardation (Rth) along the thickness of the phase compensation plates 33 and 37 is 120 nm to 200 nm and, more preferably, 160 nm. The optical phase retardation of the optical compensation film 31 is 100 nm to 150 nm and, more preferably, 135 nm. FIG. 3B is a whole-angle view of the liquid crystal display according to the preferred embodiment of the present invention. An isocontrast line 39 represents a view angle area at a contrast of 10:1. The contrast and the view angle shown in FIG. 3B are better than that are shown in FIG. 2C.

As mentioned above, by means of two phase compensation plates and an optical compensation film, the present invention reduces the dark-state leakage and oblique leakage of an optically compensated bend mode liquid crystal display.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A liquid crystal display with optical compensation, the liquid crystal display using an optically compensated bend mode, the liquid crystal display comprising:
a first substrate;
a second substrate located parallel to said first substrate;
a liquid crystal layer between said first substrate and said second substrate, wherein liquid crystals of said liquid crystal layer are arranged in an optically compensated bend mode;
a first phase compensation plate located outside said first substrate;
a second phase compensation plate located outside said second substrate;
an optical compensation film located outside said first phase compensation plate;
a first polarizer located outside said optical compensation plate; and
a second polarizer located outside said optical compensation plate.

2. The liquid crystal display according to claim 1 wherein the optical phase retardation of the liquid crystal layer is 400 nm to 800 nm.

3. The liquid crystal display according to claim 1 wherein the pre-tilt angle of the liquid crystal layer is 6° to 10°.

4. The liquid crystal display according to claim 1 wherein said first phase compensation plate comprises layers of liquid crystals.

5. The liquid crystal display according to claim 4 wherein said liquid crystals comprises discotic liquid crystals.

6. The liquid crystal display according to claim 4 wherein the tilt angle of said liquid crystals of said first phase compensation plate near said first substrate is 30° to 40°.

7. The liquid crystal display according to claim 4 wherein the tilt angle of said disc-shaped liquid crystals of said first phase compensation plate far from said first substrate is 0° to 5°.

8. The liquid crystal display according to claim 1 wherein the optical phase retardation of said first phase compensation plate along the thickness is 120 nm to 200 nm.

9. The liquid crystal display according to claim 1 wherein said second phase compensation plate comprises layers of liquid crystals.

10. The liquid crystal display according to claim 9 wherein said liquid crystals comprise discotic liquid crystals.

11. The liquid crystal display according to claim 9 wherein the tilt angle of said liquid crystals of said second phase compensation plate near the second substrate is 30° to 40°.

12. The liquid crystal display according to claim 9 wherein the tilt angle of the liquid crystals of the second phase compensation plate far from the second substrate is 0° to 5°.

13. The liquid crystal display according to claim 1 wherein the optical phase retardation of the second phase compensation plate along the thickness is 120 nm to 200 nm.

14. The liquid crystal display according to claim 1 wherein said optical compensation film comprises a single-axis extension retardation plate.

15. The liquid crystal display according to claim 14 wherein the included angle of retardation axis of said single-axis extension retardation plate and the absorption axis of said first phase compensation plate comprises 90°.

16. The liquid crystal display according to claim 14 wherein the optical phase retardation of the optical compensation film is 100 nm to 150 nm.

17. The liquid crystal display according to claim 1 wherein the included angle of the absorption axis of said first polarizer and the absorption axis of said second polarizer comprises 90°.
